(19) United States
(12) Patent Application Publication
(10) Pub. No.: US 2009/0307366 A1
(43) Pub. Date: Dec. 10, 2009

(54) Method for data stream transmission

(76) Inventors: Olaf Erb, Grafing (DE); Per Vindeby, Munchen (DE)

Correspondence Address: STAAS & HALSEY LLP, SUITE 700, 1201 NEW YORK AVENUE, N.W., WASHINGTON, DC, 20005, US

(21) Appl. No.: 11/920,654

(22) PCT Filed: May 17, 2005
(86) PCT No.: PCT/EP2005/005358

§ 371 Date: Apr. 14, 2009

(51) Int. Cl. G06F 15/16

(52) U.S. Cl. 709/231

(57) ABSTRACT

A method transmits contents of a continuous data stream from a first server to a terminal, whereby the contents are provided by a source and transmitted to the first server. An associated piece of information is provided by the source for each content item and the information which can be allocated to the contents of the transmitted data stream are transmitted to the terminal by means of another server.

This application is based on and hereby claims priority to PCT Application No. PCT/EP2005/005358 filed on May 17, 2005 the contents of which are hereby incorporated by reference.

### BACKGROUND

The invention relates to a method for transmission of a continuous data stream from a first server to a terminal.

Particularly for multimedia applications, a transmission technique which is referred to as “streaming” is becoming increasingly important. In this case, a continuous data stream is transmitted to a terminal, which is referred to as a “client”. Typical applications for streaming transmission methods are, for example, transmissions of music videos or of pieces of music to a mobile terminal subscriber.

If, for example, the terminal subscriber requests music video clips from a hit parade list, then each of the individual music video clips is requested individually, and is transmitted correspondingly individually to the terminal, which is referred to as the “client”.

Known transmission techniques and transmission standards are used for carrying out the streaming transmission, for example by GPRS, UMTS, WLAN or DSL.

During “streaming”, the transmitted information is generally not temporarily stored, but are reproduced directly at the terminal end. The “streaming” transmission method therefore differs from the known “download” method, in which file content can in general be displayed or reproduced only after the file has been completely downloaded.

Use of “streaming” makes it possible to use terminals which have only small internal memory capacities to display the streaming contents. In this case, the only data that is transmitted is advantageously that which is actually being consumed at the subscriber end.

“Streaming” transmission methods are advantageously used to transmit large amounts of data, also including the music videos or pieces of music mentioned initially.

The contents are produced by a source, which is referred to as a “repository” and are transmitted to a so-called streaming server.

The streaming server then transmits the individual contents as separate, continuous data streams using known streaming and signaling protocols to the subscriber terminal.

The terminal reproduces the contents, and/or displays them, using a reproduction device which is referred to as a “player”. In this case, in a comparable manner to a known tape recorder, it is possible for the terminal subscriber to carry out a “forward” or “fast-forward” function, or a “rewind” function during the data stream. This therefore makes it possible for the terminal subscriber to influence the sequence of the contents of the data stream, and therefore its reproduction time duration.

Methods are known in which a plurality of pieces of music are combined as contents to form a continuous data stream, and are transmitted without interruption to a terminal.

In this case, a terminal subscriber can monitor the streaming server and/or the source to a relatively wide extent. This therefore makes it possible, in a comparable manner to a conventional CD player, for the terminal subscriber to carry out the function of skipping a piece of music during the data stream. This function is generally referred to as “skipping”.

However, for this purpose, the standardized signaling protocols used, for example the RTSP protocol for the 3GPP standard, between the terminal and the streaming server must be upgraded. Appropriate control commands and confirmation signals are interchanged between the “client” on the one hand and the streaming server on the other hand.

### SUMMARY

One possible object is therefore to specify a method by which a terminal subscriber can influence the display or the reproduction of a continuous data stream or of data stream contents with little additional effort.

The inventors propose a method for transmitting contents of a continuous data stream from a first server to a terminal. With this method, the contents are produced by a source and are transmitted to the first server. The source produces respectively associated information for each content, with that information which can be associated with the contents of the transmitted data stream likewise being transmitted to the terminal.

The method makes it possible for the terminal subscriber to specifically select individual contents or media objects in a continuously transmitted data stream on the basis of the transmitted information, and to display the selected contents as desired.

In this case, the information is transmitted in parallel with and separately from the contents. It is particularly advantageous to transmit the information using standardized signaling protocols.

However, the expression “media objects” does not just mean, for example, exclusively video clips, pieces of music, trailers (“teasers”), available ringing tones, etc.

The method can be used, for example to display additional information relating to a movie section as a media object in the data stream, such as the start of the movie within a region or information about a film music CD available relating to the movie, or information relating to reviews of the movie.

It is likewise possible to display the title, the text, the performer, the performer's tour dates or the like as additional information relating to a piece of music transmitted as the media object.

So-called function options can also be transmitted as information, which a terminal can use to determine selection options for a subscriber.

If, for example, no appropriate ringing tone is offered for downloading for example for a reproduced piece of music, then no download option is indicated to the subscriber, either. This prevents the subscriber from using his terminal to request a ringing tone download which can be recognized as being impossible only at the network end. This avoids unnecessary request transmissions between the terminal and the network-end servers.

If an audio book is transmitted as the content of a “streaming” data stream, then the terminal subscriber can use the transmitted information to select individual chapters without losing time, and if required, to skip chapters that have already been listened to or are of no interest.

The method makes it possible for the terminal subscriber to use markings, entry points, references etc. which are transmitted as information to specifically find one content item within the continuous data stream and to reproduce that content starting at the marking or to skip the entire contents.

In this case, by way of example, a marking can define the start of a media object or of a content item or can indicate its length, with the marking being transmitted as information associated with the media object.

When teasers are transmitted as media objects, the information that is transmitted makes it possible for the terminal customer to call up appropriately associated advertising data, if he is interested.

In one advantageous development, a provider records and analyses respective requests or information calls from the terminal subscriber, and creates appropriately suitable advertisements based on this, selects them and transmits them specifically to that terminal subscriber.

So-called “teaser” clips could therefore be played specifically as a function of the selected music performers, in order to advertise that the preferred performer has a CD on sale, or in order to offer a preferred type of music or further music titles to the terminal subscriber.

The method is suitable not only for transmission of so-called “static” data stream contents but also for transmission of so-called “dynamic” contents of the data stream.

The expression “static” means a streaming method in which contents that are offered are transmitted from the source, which is referred to as the “repository” in a predetermined sequence of fixed length to the streaming server. This includes, for example, pieces of music from the top-10 hit-parade list, which are transmitted, combined to form a data stream, in accordance with their position in the hit parade.

In the case of the static streaming method, it is possible, for example, for the source, which is referred to as “repository”, to combine the contents in advance to form a data stream. This is referred to in the following text as “preassembled”.

As an alternative to this, it is possible to combine the contents on the basis of a static list only in response to a call from the terminal subscriber. This “pseudo-static” streaming method is referred to in the following text as “on-demand assembled”. The combination process, which is carried out for example by a so-called “media object concatenation server”, is preferably controlled by a so-called “content information server”, and will be described in more detail in the following figure.

In this case, it is also possible for the “content information server” to be influenced or controlled by the terminal or by the subscriber.

The expression “dynamic” is used to mean a streaming method in which contents on offer are produced individually by the source, which is referred to as the “repository”. A desired choice of the contents or of the media objects is made by the terminal subscriber. By way of example, these contents are transmitted from the source to a so-called “media object concatenation server”, as soon as they are called up.

A dynamic data stream with an appropriate content sequence is formed in said media object concatenation server as a function of the choice, and is transmitted via a “streaming server” to the subscriber terminal, as soon as these contents are called up.

For example, only a plurality of selected pieces of music are selected from a hit parade list that is on offer, and these are transmitted in the desired sequence, combined to form a data stream.

It is also possible to reproduce only sections of the media objects or contents. For example, pieces of music are “played back” in each case only for a period of 30 seconds, but without charging for this. These advertisement offers of the pieces of music, which are referred to as “teasers”, can then be requested by the subscriber, if required, in their entirety with fees being calculated. One advantageous feature of these “teasers” is that there is no need for the source to provide appropriately shortened 30-second contents. The “media object concatenation server” forms the “teasers” with an appropriate length. In one advantageous development, this is controlled by the “content information server” which, for example, is in turn controlled by the subscriber by an “application” service device or by an owner of the contents.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows one embodiments of the proposed method in the form of a block diagram,

FIG. 2 shows a flowchart relating to the initialization of a dynamic data stream and skipping of a content item in the data stream,

FIG. 3 shows a flowchart relating to the skipping of a content item in a dynamic data stream, and

FIG. 4 shows a flowchart relating to a static data stream and skipping of a content item.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

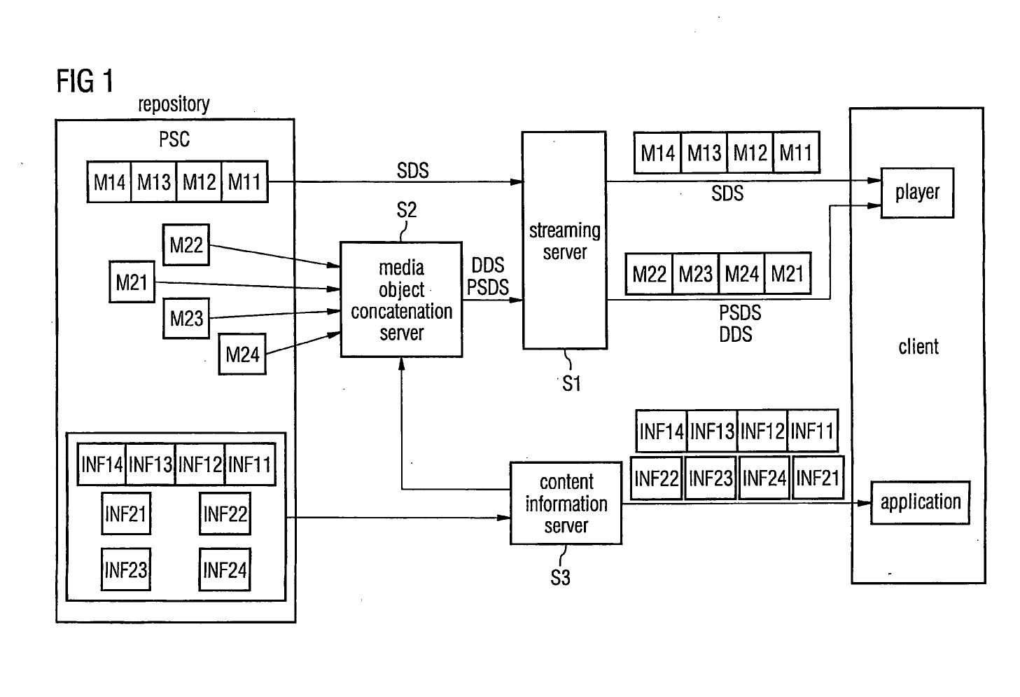

FIG. 1 shows the proposed method in the form of a block diagram.

A source which is referred to as a “repository” provides, for example, eight media objects M11, M12, M13, M14 as well as M21, M22, M23 and M24 as contents.

When combined, the contents M11, M12, M13 and M14 form a so-called “preassembled static content, PSC” of a static data stream SDS, while the contents M21, M22, M23 and M24 occur individually for a pseudo-static data stream PSDS to be formed and/or a dynamic data stream DDS.

The contents M11, M12, M13 and M14 are transmitted as a static data stream SDS via a first server S1, which is referred to as a streaming server and is of a known type, to a terminal subscriber client, where they are displayed using a reproduction device player.

A second server S2 is arranged between the source repository and the first server S1, and is referred to as a “media object concatenation server”, which is used to combine the contents M21, M22, M23 and M24, which are transmitted individually from the source repository, to form a pseudo-static data stream PSDS or dynamic data stream DDS, which is transmitted via the first server S1 to the reproduction device player of the terminal subscriber client.

In addition to each of the contents M11, M12, M13 and M14, the source repository transmits respectively associated information INF11, INF12, INF13 and INF14 to a third server S3, which is referred to as the “content information server”.

In a corresponding manner, the source repository transmits respectively associated information INF21, INF22, INF23 and INF24, associated with each of the contents M21, M22, M23 and M24, respectively to the third server S3.

In parallel with the transmitted contents M11, M12, M13 and M14 in the static data stream SDS and in a corresponding sequence, the third server S3 sends the respectively associated information INF11, INF12, INF13 and INF14 to a service device application, which thus provides the information INF11, INF12, INF13 and INFM14 for the terminal or for the terminal subscriber client.

In a corresponding manner, and in parallel with the transmitted contents M21, M22, M23 and M24 of the pseudo-static data stream PSDS or the dynamic data stream DDS and in a corresponding sequence, the third server S3 sends the respectively associated information INF21, INF22, INF23 and INF24 to the service device application, thus providing the contents INF21, INF22, INF23 and INF24 for the terminal subscriber client.

The sequence of the contents M21, M22, M23 and M24 is in this case controlled by the third server S3, which is connected to the second server S2. The third server S3 in this case also ensures that the information INF21, INF22, INF23 and INF24 is transmitted in the correct sequence and at the correct time to the terminal subscriber client.

For example, the information INF21 and INF24 is transmitted in parallel with the transmission of the content M21 in order to allow the terminal subscriber to skip if required.

Only the respectively required information INF is ever transmitted—defined and controlled by the third server S3.

In the case of the pseudo-static data stream PSDS, all of the information INF21, INF22, INF23 and INF24 can be transmitted at once, since these items are already defined in the sequence. The information INF makes it possible for the subscriber to select a desired content as required, as in the case of a static data stream.

The information INF11, INF12, INF13 and INF14 produced by the source repository and relating to the static data stream SDS is advantageously produced as a so-called “content description”. The “content description” contains, for example, descriptions, referred to as “metadata”, of the respectively associated contents.

In the pseudo-static data stream PSDS, the sequence of the contents is defined by the third server S3 on the basis of a static list with the list being available in the source repository.

In one advantageous development, the sequence of the selected contents and their associated information items is controlled by the third server S3, using a random principle in the dynamic data stream DDS. The selection of the contents can also be controlled by the third server S3 on the basis of a user profile that has been created.

This makes it possible to offer the terminal subscriber client contents and associated information based on his personal, randomly controlled, entertainment choices.

This functionality is in one advantageous development carried out by a so-called “proposal engine”, which is associated with the third server S3, although this is not illustrated here.

The information items INF11 to INF14 contain and define, for example, the position of the respectively associated contents in the static data stream SDS or the start of the content or its time duration, etc. This makes it possible for the terminal subscriber to skip between the contents during reproduction.

This also applies to the pseudo-static data stream PSDS, for the situation in which the information INF21 to INF24 defines the position of the respectively associated contents in the data stream PSDS or the start of the content, or its time duration, etc.

In one preferred embodiment, timing details that are required are specified using time offset values relating to a first content. A time offset value can be transmitted from the service device application to the reproduction device player in order to skip to the correct point within the static data stream SDS within an RTSP link which complies with the standard.

As an alternative to this, in the case of the pseudo-static data stream PSDS, the information INF21 to INF24 can also include transmission of an index or a reference to a time offset table, which is advantageously stored in the third server S3.

In the situation where the intention in the case of a dynamic data stream DDS is in each case for only one skip to the next content to be possible, there is no need to request or transmit an appropriate time offset value from the source repository or from the second server S2. The starting point of the respective next media object may be known to the third server S3.

Alternatively or in addition to this, the information INF11 to INF24 includes additional statements relating to the respectively associated contents, for example a piece of music to be reproduced. By way of example, this may comprise details relating to the performer or his tour data etc.

This makes it possible for the terminal subscriber to call up all the details of interest relating to the reproduction of a piece of music and, if required to purchase a ticket for a live event.

In the case of the dynamic data stream DDS, the third server S3 transmits current information to the subscriber terminal client as soon as new content is inserted into the data stream DDS by the first server S1. In this case, the information is transmitted in parallel and separately from the contents. It is particularly advantageous to transmit the information without using standardized signaling protocols, for example the standardized RTSP signaling protocol that was mentioned initially. This results in increased flexibility.

The information can also be used to bill the terminal subscriber client for the respectively associated and requested contents.

By way of example, a content item is reproduced, subject to paying within a time interval for an amount which may have been cleared for that subscriber. Reproduction of the content is ended when that amount is reached.

A time synchronization method is used in order to achieve time discrepancies and synchronization between the transmitted contents and their associated information items.

In a first synchronization method, the synchronization is carried out within the terminal client between the reproduction device player on the one hand and the service device application on the other hand. For example, a time reference to the respective contents is produced on the basis of time offset values, which have been transmitted as information.

In a second synchronization method, the synchronization is controlled by the third server S3. The third server S3 knows both the sequence of the contents and their respectively associated information by virtue of the link to the second server S2 and to the source “repository”.

In a third synchronization method, the synchronization is carried out by the terminal client. For example, an accurate internal time reference is used as a timer for this purpose.

In one advantageous development, the reproduction device player and the service device application are not arranged in a common subscriber terminal client. For example, it is possible to control a plurality of reproduction devices player via one service device application. One specific exemplary embodiment of this is the central control or remote control of a plurality of screens, which are used as reproduction devices, for the purposes of a “smart home” application.

The proposed method can also be used for a so-called “streaming over SIP” method, with the abbreviation “SIP” representing a “session initiation protocol, SIP”.

In a further advantageous development, a so-called statement relating to the information is transmitted. This defines, for example, how often the subscriber may listen to a temporary stored content item or whether the subscriber may store that content at all or whether the content will no longer be available when a prior condition (time duration) no longer applies, etc.

In addition to authorizations, the statement can also define whether music titles are also available relating to videos to be reproduced, and/or whether these are offered to the subscriber.

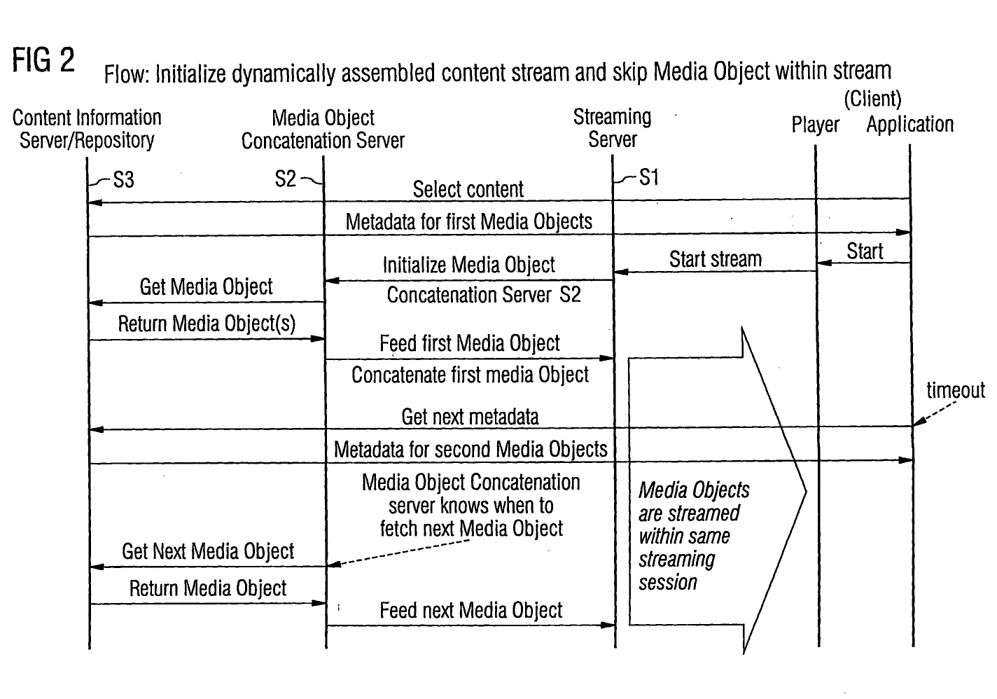

FIG. 2 shows a self-explanatory flowchart relating to initialization of a dynamic data stream, and skipping of a content item in the data stream.

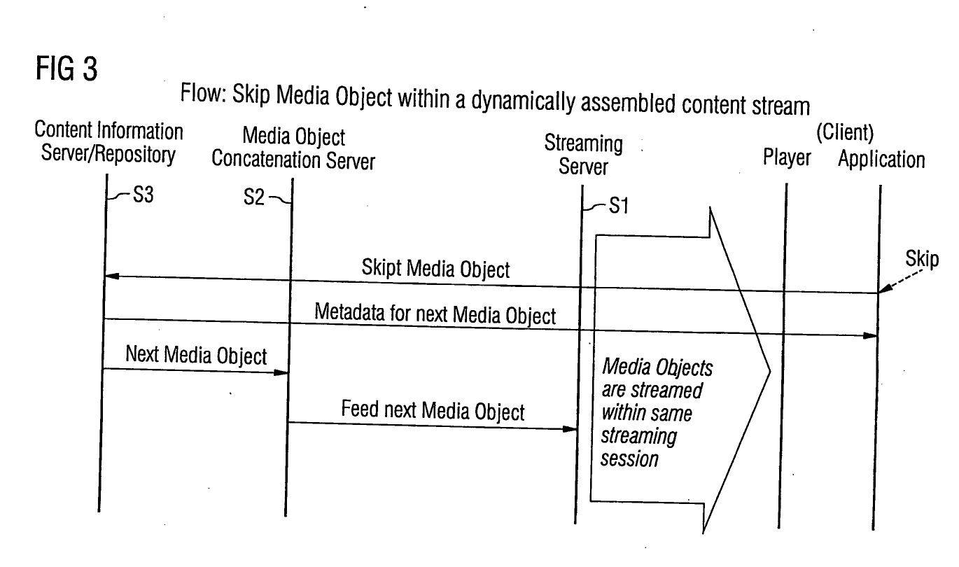

FIG. 3 shows a self-explanatory flowchart relating to skipping of a content item in a dynamic data stream.

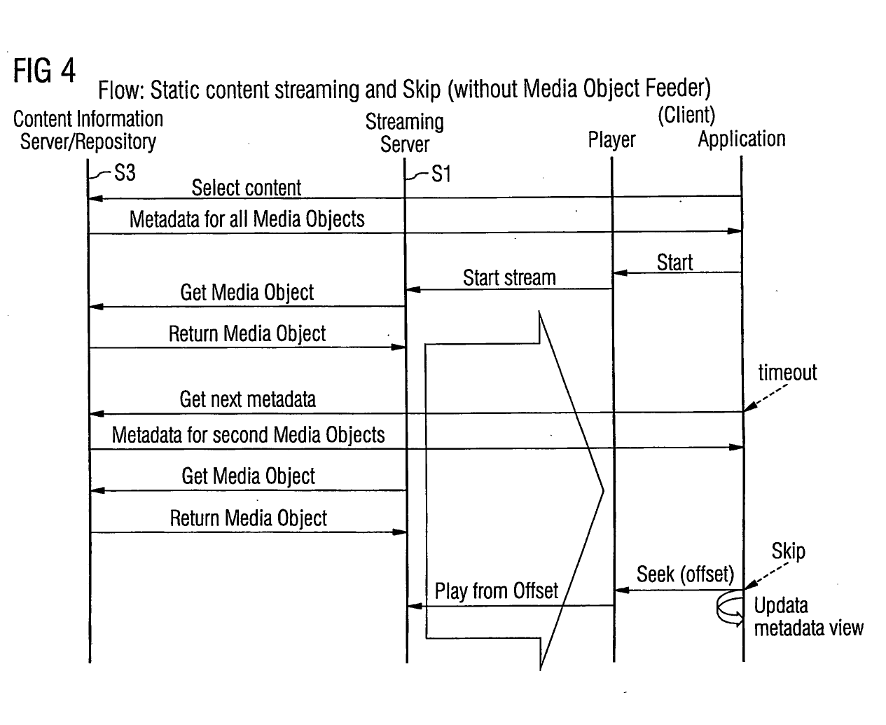

FIG. 4 shows a self-explanatory flowchart relating to a static data stream, and skipping of a content item.

The system also includes permanent or removable storage, such as magnetic and optical discs, RAM, ROM, etc. on which the process and data structures of the present invention can be stored and distributed. The processes can also be distributed via, for example, downloading over a network such as the Internet. The system can output the results to a display device, printer, readily accessible memory or another computer on a network.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-21. (canceled)

22. A method for transmitting content elements of a continuous data stream to a terminal, the content elements being produced by a source, comprising:
producing an associated information element for each content element;
individually transmitting the content elements from the source to a second server;
using the content elements to form a dynamic or a pseudo-static data stream at the second server;
transmitting the dynamic or pseudo-static data stream from the second server to a first server;
transmitting the information elements to the terminal; and
transmitting the dynamic or pseudo-static data stream from the first server to the terminal.

23. The method as claimed in claim 22, wherein information about a further server is transmitted to the terminal.

24. The method as claimed in claim 22, wherein
the terminal has a reproduction device, and
the content elements of the continuous data stream are transmitted to the reproduction device of the terminal and reproduced directly.

25. The method as claimed in claim 22, wherein the information elements are transmitted to a service device for the terminal.

26. The method as claimed in claim 25, wherein the service device allows a terminal subscriber to control a sequence of the content elements, jump-forward in the data stream or a jump-back in the data stream.

27. The method as claimed in claim 25, wherein the service device allows a terminal subscriber to perform a fast-forward function or a fast-return function.

28. The method as claimed in one of claim 25, wherein the service device represents the information elements associated with the content elements for a terminal subscriber.

29. The method as claimed in claim 22, wherein a terminal subscriber selects the information elements associated with the content elements.

30. The method as claimed in claim 22, wherein selectable information is offered to a terminal subscriber based on a user profile.

31. The method as claimed in claim 22, wherein the information elements define starting times, time durations or time offset values for the associated content elements.

32. The method as claimed in claim 22, wherein
the content elements relate to a music video or piece of music, and
the information elements define a music title, a performer, tour data for the performer or advertisements relating to the content elements.

33. The method as claimed in claim 22, wherein the content elements of the data stream are combined before being transmitted to the first server.

34. The method as claimed in claim 22, wherein a request for the content elements is controlled by at least one of a terminal subscriber, a customer profile created by the terminal subscriber, and a service provider.

35. The method as claimed in claim 22 wherein a statement relating to the information elements is transmitted to the terminal.

36. The method as claimed in claim 35, wherein the statement defines authorization required for use of the content elements and/or the information elements.

37. The method as claimed in claim 22, wherein time synchronization between the content elements and the information elements is controlled at the terminal or at a third server.

38. The method as claimed in claim 22, wherein only details of the content elements of the data stream are reproduced.

39. The method as claimed in claim 22, wherein a third server determines a content sequence based on a static list.

40. The method as claimed in claim 22, wherein the terminal offers only supported function options to a terminal subscriber.

41. A system for transmitting content elements of a continuous data stream to a terminal, comprising:
a source to produce the content elements and individually transmit the content elements, an associated information element being produced for each content element;
a second server to receive the content elements from the source, to use the content elements to form a dynamic or a pseudo-static data stream and to transmit the dynamic or pseudo-static data stream; and
a first server to receive the dynamic or pseudo-static data stream from the second server and transmit the dynamic or a pseudo-static data stream to the terminal, the terminal receiving both the content elements and the information elements.
